(19) United States
(12) Patent Application Publication
(10) Pub. No.: US 2008/0284791 A1
(43) Pub. Date: Nov. 20, 2008

(54) FORMING COLORING BOOKS FROM DIGITAL IMAGES

(76) Inventors: Marco Bressan, Grenoble (FR); Gabriela Csurka, Crolles (FR)

Correspondence Address: Gibb & Rahman, LLC, 2568-A Riva Road Suite 304, Annapolis, MD, 21401, US

(21) Appl. No.: 11/749,807

(22) Filed: May 17, 2007

(51) Int. Cl. G09G 5/02; G06T 11/00

(52) U.S. Cl. 345/589; 345/581

(57) ABSTRACT

Embodiments herein include a method, service, apparatus, etc., that automatically generates a coloring book image that includes line drawings defining a small number of color coherent, clearly discriminated, closed regions while preserving the basic semantic properties of the original image. These regions hence can be filled in with colored inks, crayons, paints, etc. The method inputs a color image that can be a photograph, scanned image, etc. The method begins by transforming the color image into a chrominance-luminance space and then performs low pass filtering on the color image that preserves the chrominance edges of the features within the color image. Next, the method segments the color image into the features based on locations of the chrominance edges of the features. Then, the method can merge selected features into other features. After performing any merging, the method identifies the remaining chrominance edges of the features within the image and adds lines along the remaining chrominance edges to form outlines of the features. Then, the method automatically filters out all other data from the image to leave only the outlines and produce a revised image consisting of just the outlines. The revised image of just outlines is then output to the user.

### BACKGROUND AND SUMMARY

Embodiments herein generally relate to the automatic creation of coloring sheets and coloring books from digital images and photographs.

Coloring is a preferred activity for a large number of children. Many coloring books and related exercise books are sold every year worldwide. Hundreds of web coloring pages are readily available (e.g. [11]-[17]) but, since hand-coloring is still preferred, these pages need to be printed before being hand colored (note that references to articles and publications are made by number in the text herein, and a full listing of the references appears before the claims section below). Embodiments herein enable such coloring drawings to be automatically created from arbitrary images, such as photographs.

The embodiments herein provide a method for processing a color digital image to obtain an image resembling those typically found in children's coloring books. The challenge in generating coloring book image and, in consequence, of our system is, given a digital image, to find a transformation that results on a small number of color coherent, clearly discriminated, closed regions while preserving the basic semantic properties of the original image.

Embodiments herein are suitable for generating different types of content, e.g. silhouettes for unsupervised coloring, borders with numbered regions, etc. The possibility of generating coloring images from arbitrary images opens the possibility to new types of coloring content. The methods herein are applied to an image set in order to obtain a complete coloring book. Embodiments herein utilize a number of parameters which show good performance across a wide range of images to allow for automated implementation in a photographic print flow.

While some conventional disclosures discuss the creation of coloring books, each conventional system experiences certain drawbacks. For example, U.S. Patent Publication 2002/0003631 (the complete disclosure of which is incorporated herein by reference) discloses the creation of a coloring book from digital images. In this publication a line-art image is rendered from a digital image. The line-art image is formatted to produce a coloring book image and the coloring book image is printed. Further, this publication discloses that an index number may be assigned to a corresponding sample color and the index number and color may be printed with the coloring book image to produce a color-by-numbers coloring book image. Further, U.S. Pat. No. 6,238,217 (the complete disclosure of which is incorporated herein by reference) discloses a video coloring book preparation system that includes a processor, a display device and a selecting device.

Such conventional systems discuss the idea of generating a coloring book image from arbitrary photographs, but do not specify a way of accomplishing such a function. Some conventional methods refer to “rotoscoping” as the global way of rendering a digital image, but do not go into the details of how this is accomplished. Rotoscoping is usually supervised or semi-supervised. To the contrary, embodiments described herein provide an approach of how image processing can be performed, in the particular case of coloring book image generation, using a method that is automatic (non-supervised).

Similarly, U.S. Pat. No. 6,356,274 (the complete disclosure of which is incorporated herein by reference) discloses a computer system for converting a colored picture into a color in-line drawing. Also, U.S. Pat. No. 6,061,462 (the complete disclosure of which is incorporated herein by reference) discloses many aspects of rendering line art from photographic images. U.S. Patent Publication 2002/0012003 (the complete disclosure of which is incorporated herein by reference) discloses a method of automatically transforming an arbitrary pixel image into a corresponding simulated water color like image.

These approaches do not target the creation of images for coloring books. In consequence, the processed images are not suitable for this purpose. Coloring book images, by nature should take color information into account. Some of the named approaches work on top of a single luminance channel. Coloring book images typically consists in closed regions, clearly discriminated one from the other. This makes the task of coloring simple, especially when the target audience is children. Some of the named approaches only use edge-detection information for generating the line-art. This approach seldom results in closed regions or in regions that correspond to unique colors. Finally, coloring book images rely on the semantic image content. For this purpose, higher-level processing such as object detection, recognition, segmentation, etc. is necessary. None of these approaches are considered in the conventional methods.

Additionally, DeCarlo and Santella [1] propose a system for transforming images into line-drawings using bold edges and large regions of constant color. To do this, they represent images as a hierarchical structure of parts and boundaries computed using state-of-the-art computer vision. However, their system is a complex interactive system that needs to identify meaningful elements of their hierarchical structure through gaze detection.

One disclosure by Hans du Buf et al., [2] discloses an automatic painterly rendering method that is based on a multi-scale edge and keypoint representation. The idea in that disclosure is to automatically create the salience maps for Focus-of-Attention, instead of using eye movement recordings. To do the stylization they first apply an Automatic Color Equalization (ACE) color constancy model to create the background image and then apply brush strokes guided by line/edges and the saliency map.

Another method proposed by Olmos et al. Kingdom [3] provides a non-photorealistic rendering algorithm that produces “stylized-style” images by removing the soft shading from the image and by giving objects extra definition through black outlines. The idea is to combine edges at each chromatic plant (RG and BY) and accordingly classify the image derivatives in R, B, and G (red, green, and blue). Stavrakis et al. [8] also propose a method of stylization of a stereo pair images based on depth information and the disparity map.

Work has also been done in video abstraction and stylization. For example, Fisher and Bartz [4] apply a cartoon-like stylization on augmented reality video streams. In this case the virtual object is overlaid on the image and therefore its contours are easily captured. Winnemöller et al. [5] present an automatic image abstraction framework that abstracts imagery by modifying the contrast of visually important features, namely luminance and color opponency. They reduce contrast in low-contrast regions using an approximation to anisotropic diffusion, and artificially increase contrast in higher contrast regions with difference-of-Gaussian edges.

Wang et al. [6] present an approach of transformation of a real video in a spatio-temporally coherent cartoon animation. The specification of the semantic regions is done interactively and regions are filled accordingly either by pixel coloring (e.g. for faces) allowing users to draw their own sub regions or using paint-like strokes.

While these conventional methods might focus on different techniques for rendering images, their approaches are not suitable for coloring book image generation. The techniques usually output rendered images which take into account both color and edge or region processing, so coloring is clearly not their purpose. Alternatively, if the color information is discarded, the edges provide regions which are not necessarily optimal for a coloring book, e.g., open regions, multiple colors per region, no high level processing such as image object detection and recognition etc.

In addition, most of these conventional methods will not work directly to get “coloring pages” because of the poor quality of the edge map. Such conventional systems produce many non-closed features or features with missing relevant edges. However, by merging the chrominance and luminance edges, the embodiments herein mutually compensate for the visual imperfections commonly found in amateur photography, leading to a visually acceptable stylized effect for coloring pages.

One specific embodiment presented below comprises a method of automatically generating a coloring book image that includes line drawings defining a small number of color coherent, clearly discriminated, closed regions while preserving the basic semantic properties of the original image. These regions hence can be filled in with colored inks, crayons, paints, etc. The method inputs a color image that can be a photograph, scanned image, etc. The method begins by transforming the color image into a chrominance-luminance space and then performs low pass filtering on the color image that preserves the chrominance edges of the features within the color image. Next, the method segments the color image into the features based on locations of the chrominance edges of the features.

Then, in order to simplify and clean up the drawing, the method can merge selected features into other features (e.g., can merge a number of smaller features into larger, but similar features). After performing any merging, the method identifies the remaining chrominance edges of the features within the image and adds lines along the remaining chrominance edges to form outlines of the features. Then, the method automatically filters out all other data from the image to leave only the outlines and produce a revised image consisting of just the outlines. This filtering can be varied to simply remove some texture from the revised image or can be more aggressive and remove all outlines and features from the background regions of the revised image. Thus, the original color image can comprise a photograph or similar item, while the revised image is only a monochromatic line drawing. The revised image of just outlines is then output to the user.

In another embodiment, a different method of automatically generating a coloring book image is presented that similarly processes an input digital image into a coloring book line drawing. However, in this embodiment, some sections of the digital image are overlaid on the coloring book line drawing to produce a combination image and line-art drawing, which is output to the user. For example, the digital image can comprise a color photograph and the coloring book line drawing comprises a monochromatic line drawing, such that the combination image and line drawing comprises color photographic sections overlaid on (substituted for) corresponding portions of the monochromatic line-art.

In some variations of this embodiment, the process can receive user input to identify the sections of the digital image that are to be overlaid on the coloring book line drawing. In other variations, the process can automatically identify the sections of the digital image. For example, the sections of the digital image that are to be overlaid on the line-art can be automatically identified by comparing colors of the areas of the digital image with standard colors of user desired features and/or by comparing shapes of the areas of the digital image with standard shapes of user desired features.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating an embodiment herein;

FIG. 2 is a flow diagram illustrating an embodiment herein;

FIG. 3 is a schematic representation of image processing and color page creation according to embodiments herein;

FIG. 4 is a schematic representation of image processing and color page creation according to embodiments herein;

FIG. 5 is a schematic representation of image processing and color page creation according to embodiments herein;

FIG. 6 is a schematic representation of image processing and color page creation according to embodiments herein; and

FIG. 7 is a schematic representation of a system according to embodiments herein.

### DETAILED DESCRIPTION

Children enjoy coloring. If given the option, children will prefer to select the pictures they want to color, e.g., characters from their favorite cartoons, images from a particular subject they find in the internet, personal family photos, etc. In addition, children like browsing their own family albums and looking at their own photos. Coloring images (sheets to be colored) are generally simple black and white silhouette or border images with well separated regions, each corresponding to a different color. These images can also present several differences in style. One challenge addressed by embodiments here is to obtain coloring images from the arbitrary types of images children might be interested in coloring (i.e., photographs and cartoons). This problem can be seen as a particular case and application of photographic stylization and abstraction. Thus, the embodiments herein provide processes, systems, services, computer programs, etc. for the automatic creation of coloring sheets and coloring books from digital images and photographs.

When using the embodiments herein, in one example, the user selects a set of photos from an album that the user would like to include in a coloring book. The system processes those photos and outputs the coloring pages using a fully automated approach with a predefined style. The user can accept or reject these images, require the system to reprocess some photos with customized parameter sets (e.g. finer or coarser segmentation; resolution, etc), take the interactive approach for region-specific processing, or change the coloring image style.

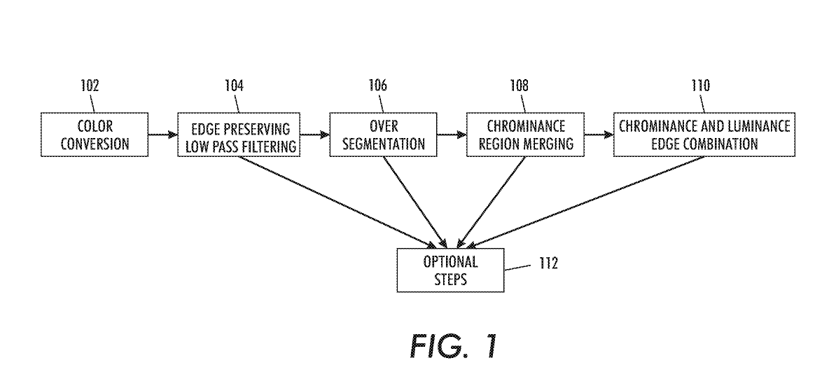

FIG. 1 is a flow diagram illustrating elements of an embodiment herein. More specifically, in item 102 the method performs color conversion by transforming the color image into a chrominance-luminance space. Then, in item 104, the method performs edge preserving low pass filtering on the color image that preserves the chrominance edges of the features within the color image. Next, the method over segments the color image (item 106) into the features based on locations of the chrominance edges of the features.

Then, in order to simplify and clean up the drawing, the method can merge chrominance regions (e.g., can merge a number of smaller features into larger, but similar features) in item 108. In other words, when merging items in item 108, the embodiments herein can eliminate (remove) some or all of the smaller items that are within the larger items, to leave just the larger items. After performing any merging, the method identifies the remaining chrominance edges of the features within the image and adds lines along the remaining chrominance edges in a chrominance and luminance edge confirmation process (item 110) to form outlines of the features. Item 112 represents a number of optional steps, which are discussed below.

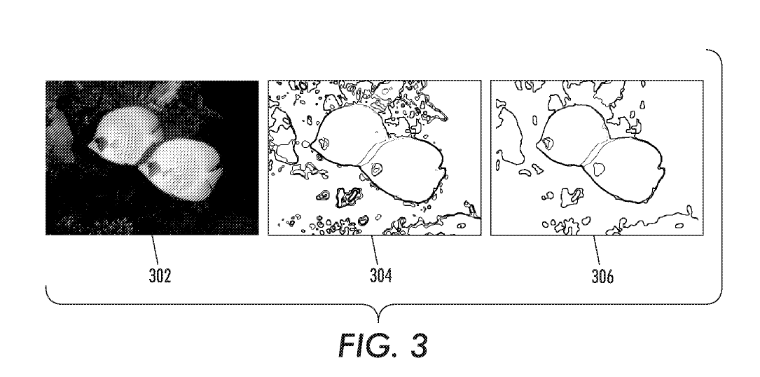

Thus, the method automatically filters out all other data from the image to leave only the outlines (e.g., FIG. 3, item 306) and produce a revised image consisting of just the outlines. This filtering can be varied to simply remove some texture (e.g., items 304 vs. 306 in FIG. 3) from the revised image or can be more aggressive and remove all outlines and features from the background regions of the revised image, based on user input and refinement. The original color image can comprise a photograph or similar item, while the revised image can be only a monochromatic line drawing. The revised image (containing just the outlines) is then output to the user.

More specifically, item 102 represents a transform of the smoothed image from RGB (red, green and blue) space to some chrominance-luminance space such as YIQ or L*ab (National Television Systems Committee (NTSC) YIQ video format; and Luminance “a” direction and “b” direction, respectively). With L*ab space the Euclidean distance has a perceptual interpretation and this can be of advantage for metric-based stages such as clustering.

With respect to the edge-preserving low-pass filter (EPLP) in item 104, the filtering is applied to the different channels of the image. This filtering reduces image noise (which can lead to extra edges or image segments non-relevant for further processing). Digital cameras often introduce strong noise in the chrominance channel and this can degrade performance. Scanned images can also present halftoning artifacts which are reduced at this stage. Therefore, the filtering step 104 improves performance by removing such noise and artifacts. Simple median filtering can be used, or some more sophisticated methods such as edge-preserving maximum homogeneity neighbor filtering [7] or anisotropic diffusion filtering [8]. For example, embodiments herein can apply the smoothing in the luminance-chrominance space (chosen to be L*ab) with higher smoothing parameters for the chrominance (e.g., 7 for luminance and 11 for chrominance). The EPLP could be alternatively applied directly to the RGB image.

Item 106 provides image segmentation or region clustering. Some segmentation/clustering approaches that can be used include Normalized Cut based segmentation [9], Mean Shift based segmentation [10] and their respective improvements. These methods have the advantage over traditional K-means clustering, in that they take into account the spatial closeness of the pixels and therefore lead to more compact segments. For example, the embodiments herein can use Mean Shift based segmentation with flat kernel and a low color bandwidth (˜5). The bandwidth parameter allows handling the coarseness similarly in different images without specifying the exact number of clusters in the image. However, the embodiments can also use a simple K-means algorithm in L*ab space with the Euclidean distance for its computational convenience, and then replace each pixel's value with the value of its respective cluster center. In this case, the coarseness of the segmentation depends on the user-selected value of K. In item 106 some embodiments can intentionally use a low bandwidth (high value for K, in K-means) to over-segment the image. By over-segmenting, embodiments herein can ensure that they do not miss any perceptually important boundary. The amount of over-segmentation can be controlled based on user input, as discussed below.

In item 108, the criterion for merging two regions is both spatial and perceptual. Informally, if two spatially neighboring regions are also close in chrominance space (e.g. Threshold=20 when a,b∈[−128,128]) and not too far in luminance, the smallest one will be merged with the biggest one (e.g. threshold=20 when L∈[0,256]). This is shown, for example, in FIG. 3 where item 302 represents the original input image (which in this example is a photograph), item 304 represents the initial line-art drawing, and item 306 represents the line-art drawing after smaller items have been merged into larger items. By so merging the items, the line-art drawing is easier for the user to color (because less potentially different colored items need to be distinguished); yet the drawing still maintains some of the background features (as opposed to some methods that completely remove all background features). Therefore, the merging feature provides a good balance between having too many different items for the user to color, and having sufficient items to make the coloring page pleasant to view and color.

The merged region will generally keep the color of the larger region. If the area of the smaller region is below a given threshold (too small, e.g. smaller that 0.5% of the image area) it will be absorbed by the most similar (closest in the chrominance space) neighboring region, independently of the color difference between the two regions. This is done iteratively until no modification is made or until a maximum number of iteration is achieved. The following shows the pseudo code for this step.

REPEAT until no more modification is made or maximum iteration is reached

FOR each cluster
FOR each connected components
   Find the neighbor with most similar color in chrominance space
IF the color difference between them is smaller than a threshold OR the region is smaller than a minimum size
   THEN merge the smaller region with the bigger one
   ELSE continue with the next connected component

In item 110, the embodiments herein extract the contours of the remaining regions. For certain cases (e.g. very simple images well segmented and uncluttered) chrominance edges alone can be used to find the outlines; however, for more complex images it may be not ideal to just use chrominance edges and, therefore, embodiments herein keep some textured part. For example, in item 110, this can be done by using a combination of the chrominance edges of the segmented regions with some luminance edges from the original or the smoothed image.

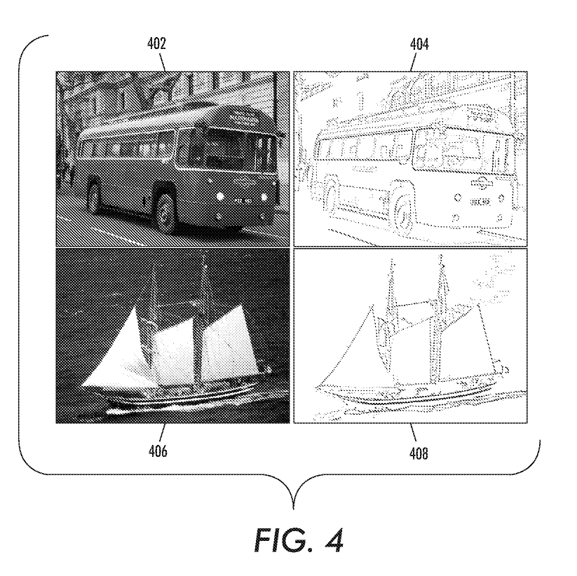

Thus, embodiments herein can combine the chrominance space and luminance to maintain a substantial amount of texture (textural information) within the coloring book image, as shown by the examples in FIG. 4. More specifically, items 402 and 406 illustrate the original input (which in these cases are photographs) and items 404 and 408 represent the highly-textural line-art drawings that are the result of the merged chrominance space and luminance. The inclusion of such texture within the line-art drawing improves the coloring sheet output provided to the user.

The combination of chrominance and luminance data can be either a simple weighted mean, logical AND/OR operator, or more some complex combination. In one example, embodiments herein use a logical AND operator between the dilated chrominance edges of the segmented regions and luminance edges. Alternatively, the embodiments herein can allow the artist coloring the coloring page to take advantage of ridges and valleys. Therefore, some embodiments can alternatively extract the ridges/valleys by ridge extractor methods. These can again be combined with the previously obtained edge maps.

Item 110 can also include various post-processing operations that are capable of eliminating various edges. For example, edges which are below a pre-determined length can be eliminated or edges which overlap one another can be fused into a single edge. Also, edges can be thickened by dilating the edge detection output. These post-processing operations can be applied to either luminance or chrominance edges, to ridges, etc. and can be executed automatically (e.g., according to default settings or previously stored user settings) or in response to user input (user refinement input). If desired, user refinement can be supplied over many iterations until the user is satisfied with the look of the coloring sheet.

Additional features of embodiments herein utilize image content understanding to improve the output. Such image content understanding provides additional tools such as a face processing tool and background processing tools. The face processing tool applies any well-known face detector or flesh tone detector to identify which portions of the input image represent facial or flesh tone features. For example, U.S. Patent Publications 2007/0041644 and 2007/0031041 (the complete disclosures of which are incorporated herein by reference) disclose some common methods for identifying facial features. Then, the original image content of faces or facial regions are overlaid on (or replace) the corresponding portions of the coloring book image. This can be useful because it is sometimes difficult to get a satisfactory edge map of facial features and users are sometimes less comfortable coloring facial features when compared to other mostly inanimate features.

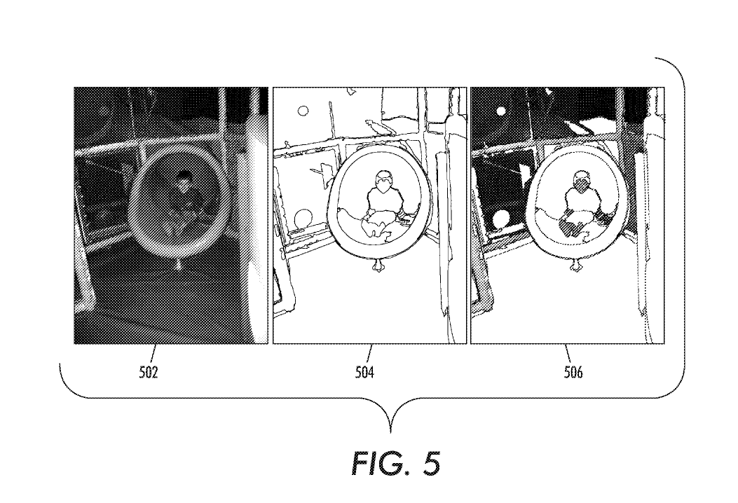

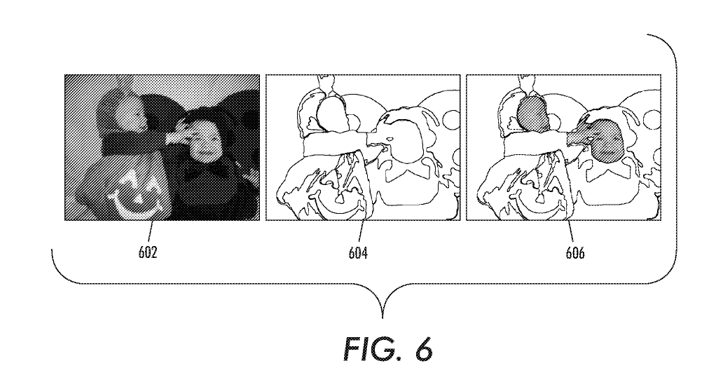

Examples of such processing are shown in FIGS. 5 and 6. Item 502 and 602 represent the original input image (in this example, the input images are photographs). Items 504 and 604 represent the coloring book image generated from the input images and items 506 and 606 represent the original flesh tone features (faces, hands) that are substituted for (or overlaid on) corresponding features in the line-art drawing. Similarly, other content understanding can be used with embodiments herein. For example, tools that recognize sky, grass, buildings, etc. can be used to substitute the images of grass, sky, etc. for the corresponding line-art features. Such substitutions (or classes of substitutions) can be set as defaults or can be tools that are selectively activated by the user. For example, U.S. Patent Publications 2005/0147298, 2006/0244757 and 2007/0005356 (the complete disclosures of which are incorporated herein by reference) disclose some common methods for identifying features such as sky, grass, bricks, sand, cars, faces, animals, buildings, etc., in images.

Content understanding can also be used to provide background processing tools that can enhance, reduce or eliminate items that are identified as background. For example, this feature of embodiments herein separates the foreground objects from the background and can enhance, reduce, or delete all edges in the background.

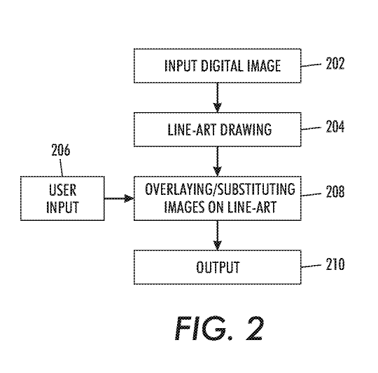

FIG. 2 illustrates the use of image content understanding in flowchart form. This processing begins with an input digital image 202 that is converted into a coloring book line drawing 204. In these embodiments, some sections of the digital image are overlaid on the line-art drawing to produce a combination image and line-art drawing 208, which is output to the user 210. The image sections are positioned in locations of the line-art drawing corresponding to identical locations where the sections were positioned in the original digital image. For example, the digital image can comprise a color photograph and the coloring book image comprises a monochromatic line drawing, such that the combination image and line-art drawing comprises color photographic sections overlaid on monochromatic line-art.

In some variations of this embodiment, the process can receive user input 206 to identify the sections of the digital image that are to be overlaid on the line-art. In other variations, the process can automatically identify the sections of the digital image. For example, the sections of the digital image that are to be overlaid on the coloring book image can be automatically identified by comparing colors of the areas of the digital image with standard colors of user desired features and/or by comparing shapes of the areas of the digital image with standard shapes of user desired features.

All the above embodiments operate with various degrees of user interaction. Thus, some embodiments use default parameters having a pre-selected output style, which results in a fully automatic coloring image generator. Alternatively, different levels of interactivity are provided by the embodiments herein. For example, a first level of interaction is provided with some embodiments which give the user the availability to switch on or off additional tools (cited above) and allows the user to accept or reject the use of such tools or the setting/modifying of some basic parameter of the system based on output results.

Such user interaction is very user-friendly, and allows the user to choose some options such as “the number of desired regions” or less/more detail, thin/thick edges, binary/gray level output. The parameter adjustment is done by the system. For example “the number of desired regions” will affect adjustments of the meanshift bandwidth and the merging parameters, discussed above.

A second level of interaction allows the user to click (using a GUI painting device) on a region which will be filled either by its original image content (see FIGS. 5 and 6) or filled in with a color by allowing the user to choose a fill color. Thus, the system allows the user to select or to upload a photo. The photo is processed as described above and the coloring page is presented to the user for further coloring/editing. The second level of interactivity described herein can be then seen as a “magical pencil” to allow the user to fill the image region with the original content of the image instead of hand coloring the output sheet. Similarly, the embodiments herein provide the user an “erasing tool” which allows the user to delete selected edges (again by using a GUI pointing device to identify which regions are to be erased).

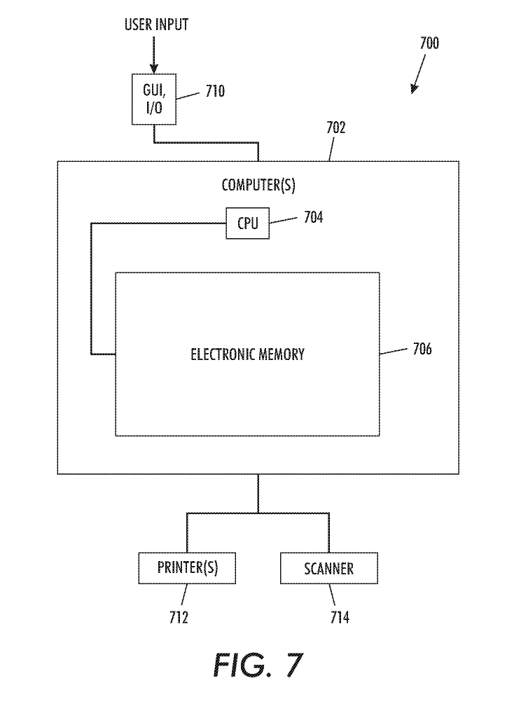

The embodiments described herein can comprise methods, services, computer programs, systems, etc. One such system 700 is shown in FIG. 7 and includes a device 702, which can comprise a computer, printer, copier, personal digital assistant (PDA), cell phone, etc. The device 702 includes a graphic user interface (GUI) or some other form of input/output (I/O) 710, one or more central processing units 704 and one or more electronic memories 706. A computer program tangibly embodying the steps outlined above can be maintained in the memory 706 and executed by the CPU 704.

Computers that include input/output devices, memories, processors, etc. are readily available devices produced by manufactures such as International Business Machines Corporation, Armonk N.Y., USA and Apple Computer Co., Cupertino Calif., USA. Such computers commonly include input/output devices, power supplies, processors, electronic storage memories, wiring, etc., the details of which are omitted herefrom to allow the reader to focus on the salient aspects of the embodiments described herein.

In addition, the device 702 can include or be connected to a printer 712, scanner 714, and/or similar peripheral devices. The word printer, copier, etc., as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art. Printers are readily available devices produced by manufactures such as Xerox Corporation, Stamford, Conn., USA. Such printers commonly include input/outputs, power supplies, processors, media movement devices, marking devices etc., the details of which are omitted herefrom to allow the reader to focus on the salient aspects of the embodiments described herein.

All foregoing embodiments are specifically applicable to electrostatographic and/or xerographic machines and/or processes as well as to software programs stored on the electronic memory (computer usable data carrier within the memory) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

### REFERENCES

[1] DeCarlo, D., and Santella, A. Stylization and Abstraction of Photographs, In ACM SIGGRAPH 2002, pp. 769-776.
[2] Hans du Buf, Jo ao Rodrigues, Samuel Nunes, Daniel Almeida, Vera Brito, Joao Carvalho, Painterly Rendering Using Human Vision, VIRTUAL, Advances in Computer Graphics in Portugal (AICG06).
[3] Adriana Olmos, Frederick Kingdom, Automatic non-photorealistic rendering through soft-shading removal: a colour-vision approach, 2nd International Conference on Vision, Video and Graphics, Edinburgh, Scotland, July 2005.
[4] J. Fischer and D. Bartz: Real-time Cartoon-like Stylization of AR Video Streams on the GPU, Technical Report WSI-2005-18, Wilhelm Schickard Institute for Computer Science, University of Tübingen, ISSN 0946-3852, September 2005.
[5] Holger Winnemöller and Sven C. Olsen and Bruce Gooch, Real-Time Video Abstraction, Proceedings of SIGGRAPH 2006.
[6] J. Wang, X., Xu, H. Shum, M. Cohen: Video Tooning. In Proceedings of ACM SIGGRAPH (August 2004), pp. 574-583.
[7] C. Garnica, F. Boochs, M. Twardochlib, A new Approach to Edge-preserving Smoothing for Edge Extraction and Image Segmentation, ISPRS Symposium, Amsterdam, The Netherlands, International Archives of Photogrammetry and Remote Sensing, Amsterdam, 2000.
[8] E. Stavrakis, M. Bleyer, D. Markovic and M. Gelautz, Image-Based Stereoscopic Stylization, in Proceedings of the IEEE International Conference on Image Processing, Genova, Italy; 2005.
[9] Jianbo Shi and Jitendra Malik, Normalized Cuts and Image Segmentation, IEEE Trans. Pattern Analysis and Machine Intelligence Vol 22 No 8, 2000.
[10] D. Comaniciu and P. Meer, Mean shift: A robust approach toward feature space analysis, IEEE Trans. Pattern Analysis and Machine Intelligence., 24, 603-619, 2002.
[11] http://www.coloring.com
[12] http://coloringbookfun.com
[13] http://www.preschoolcoloringbook.com
[14] http://www.nationalgeographic.com/coloringbook/archive/
[15] http://www.crayola.com
[16] http://www.crayola.com/activitybook/
[17] http://www.foodsafety.gov/˜dms/cbook.html

What is claimed is:

1. A method comprising:
inputting a digital image;
processing said digital image into a line drawing;
adding sections of said digital image to said line drawing to produce a combination image and line drawing; and
outputting said combination image and line drawing.

2. The method according to claim 1, wherein said digital image comprises a color photograph and said line drawing comprises a monochromatic line drawing, such that said combination image and line drawing comprises color photographic sections overlaid on said monochromatic line drawing.

3. The method according to claim 1, further comprising receiving user input to identify said sections of said digital image.

4. The method according to claim 1, further comprising automatically identifying said sections of said digital image.

5. The method according to claim 4, wherein said automatically identifying of said sections comprises at least one of:
identifying said sections by comparing colors of areas of said digital image with standard colors of user desired features; and
identifying said sections by comparing shapes of said areas of said digital image with standard shapes of user desired features.

6. A method comprising:
inputting a digital image;
processing said digital image into a coloring book line drawing;
overlaying sections of said digital image on said coloring book line drawing to produce a combination image and coloring book line drawing, such that said sections are positioned in locations of said coloring book line drawing corresponding to identical locations where said sections were positioned in said digital image; and
outputting said combination image and coloring book line drawing.

7. The method according to claim 6, wherein said digital image comprises a color photograph and said coloring book line drawing comprises a monochromatic line drawing, such that said combination image and coloring book line drawing comprises color photographic sections overlaid on corresponding locations on said monochromatic line drawing.

8. The method according to claim 6, further comprising receiving user input to identify said sections of said digital image.

9. The method according to claim 6, further comprising automatically identifying said sections of said digital image.

10. The method according to claim 9, wherein said automatically identifying of said sections comprises at least one of:
identifying said sections by comparing colors of areas of said digital image with standard colors of user desired features; and
identifying said sections by comparing shapes of said areas of said digital image with standard shapes of user desired features.

11. A method comprising:
inputting a color image comprising features;
transforming said color image into a chrominance-luminance space;
performing low pass filtering of said chrominance-luminance space that preserves chrominance edges of said features;
segmenting said color image into said features based on said chrominance edges;
merging selected ones of said features into other ones of said features;
after said merging, identifying remaining chrominance edges of said features within said color image;
adding lines along said remaining chrominance edges to form outlines of said features;
automatically filtering out data from said color image to leave only said outlines and produce a revised image consisting of said outlines; and
outputting said revised image.

12. The method according to claim 11, wherein said color image comprises a color photograph and said revised image comprises a monochromatic line drawing.

13. The method according to claim 11, wherein said filtering comprises removing texture from said color image.

14. The method according to claim 11, wherein said filtering comprises removing all outlines from background regions of said color image.

15. The method according to claim 11, wherein said merging comprises merging smaller features into larger features, thereby removing said smaller features.

16. A computer program product comprising:
a computer-usable data carrier storing instructions that, when executed by a computer, cause the computer to perform a method comprising:
inputting a digital image;
processing said digital image into a coloring book line drawing;
overlaying sections of said digital image on said coloring book line drawing to produce a combination image and coloring book line drawing, such that said sections are positioned in locations of said coloring book line drawing corresponding to identical locations where said sections were positioned in said digital image; and
outputting said combination image and coloring book line drawing.

17. The computer program product according to claim 16, wherein said digital image comprises a color photograph and said coloring book image comprises a monochromatic line drawing, such that said combination image and coloring book line drawing comprises color photographic sections overlaid on corresponding locations in said monochromatic line drawing.

18. The computer program product according to claim 16, further comprising receiving user input to identify said sections of said digital image.

19. The computer program product according to claim 16, further comprising automatically identifying said sections of said digital image.

20. The computer program product according to claim 19, wherein said automatically identifying of said sections comprises at least one of:
identifying said sections by comparing colors of areas of said digital image with standard colors of user desired features; and
identifying said sections by comparing shapes of said areas of said digital image with standard shapes of user desired features.
